(19) United States
(12) Patent Application Publication
(10) Pub. No.: US 2016/0043844 A1
(43) Pub. Date: Feb. 11, 2016

(54) OVER THE TOP METHODS FOR AGGREGATION OF WLAN CARRIERS TO LTE

(71) Applicant: QUALCOMM Incorporated, San Diego, CA (US)

(72) Inventors: Arnaud MEYLAN, San Diego, CA (US); Seyed Ali AHMADZADEH, San Diego, CA (US); Sivaramakrishna VEEREPALLI, San Diego, CA (US); Aziz GHOLMIEH, San Diego, CA (US); Gerardo GIARETTA, San Diego, CA (US); Shailesh MAHESHWARI, San Diego, CA (US); Umang Sureshbhai PATEL, Santa Clara, CA (US)

(21) Appl. No.: 14/822,556

(22) Filed: Aug. 10, 2015

Related U.S. Application Data
(60) Provisional application No. 62/036,036, filed on Aug. 11, 2014.

(51) Int. Cl. H04L 5/00; H04B 7/14; H04L 12/46; H04W 72/04

(52) U.S. Cl. CPC H04L 5/0048; H04W 72/04; H04B 7/14; H04L 12/4633

(57) ABSTRACT

Aspects of the present disclosure provide an apparatus for wireless communications. The apparatus generally includes at least one processor configured to associate with a wireless IP network, transmit to a base station, from the mobile device, a first routable address, establish a tunnel between the mobile device and the base station over a first data connection using the first routable address, and receive, packets from the base station over the wireless network using the tunnel; and a memory coupled to the processor.

### CLAIM OF PRIORITY UNDER 35 U.S.C. §119

The present Application for Patent claims benefit of U.S. Provisional Patent Application Ser. No. 62/036,036, filed Aug. 11, 2014 and assigned to the assignee hereof and hereby expressly incorporated by reference herein.

### BACKGROUND

1. Field

Aspects of the present disclosure relate generally to wireless communication systems, and more particularly, to techniques for wireless communications that utilize an aggregation of multiple radio access technologies (RATs).

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of eNodeBs that can support communication for a number of user equipments (UEs). A UE may communicate with an eNodeB via the downlink and uplink. The downlink (or forward link) refers to the communication link from the eNodeB to the UE, and the uplink (or reverse link) refers to the communication link from the UE to the eNodeB.

As wireless communication technology advances, a growing number of different radio access technologies are being utilized. For instance, many geographic areas are now served by multiple wireless communication systems, each of which can utilize one or more different air interface technologies. In order to increase versatility of wireless terminals in such a network environment, there recently has been an increasing trend toward multi-mode wireless terminals that are able to operate under multiple radio technologies. For example, a multi-mode implementation can enable a terminal to select a system from among multiple systems in a geographic area, each of which may utilize different radio interface technologies, and subsequently communicate with one or more chosen systems.

In some cases, such a system may allow traffic to be offloaded from one network, such as a wireless wide area network (WWAN) to a second network, such as a wireless local area network (WLAN) or to use aggregation to increase bandwidth using both.

### SUMMARY

Techniques for over the top methods for aggregation of WLAN carriers to LTE are described herein.

Aspects of the present disclosure provide an apparatus for wireless communications. The apparatus generally includes at least one processor configured to associate with a wireless IP network, transmit to a base station, from the mobile device, a first routable address, establish a tunnel between the mobile device and the base station over a first data connection using the first routable address, and receive, packets from the base station over the wireless network using the tunnel and a memory coupled to the processor.

Aspects of the present disclosure provide an apparatus for wireless communications. The apparatus generally includes at least one processor configured to associate a mobile device with a wireless IP network, receive, from a base station, a first routable address for establishing a tunnel between the base station and the mobile device over a first data connection, and use the first routable address to transmit packets to the mobile device over the wireless network using the tunnel, and a memory coupled to the processor.

Aspects of the present disclosure provide for an apparatus for wireless communications. The apparatus generally includes at least one processor configured to receive, from a transmitting entity, a sequence of packets delivered via at least first and second radio access technologies (RATs) and determine a transmission status based on a comparison of a sequence number associated with each packet of the sequence of packets; and a memory coupled to the processor.

Aspects of the present disclosure also provide various methods, apparatuses, and computer readable mediums corresponding to the apparatuses described above.

Various aspects and features of the disclosure are described in further detail below.

### BRIEF DESCRIPTION OF THE DRAWINGS

FIG. 1 is a block diagram conceptually illustrating an example of a telecommunications system.

FIG. 2 is a block diagram conceptually illustrating an example of a down link frame structure in a telecommunications system.

FIG. 3 is a block diagram conceptually illustrating a design of an eNodeB and a UE configured according to one aspect of the present disclosure.

FIG. 4 illustrates an example subframe resource element mapping, according to aspects of the present disclosure.

FIG. 5 illustrates an example continuous carrier aggregation type.

FIG. 6 illustrates an example non-continuous carrier aggregation type.

FIG. 7 is a block diagram illustrating a method for controlling radio links in multiple carrier configurations.

FIG. 8 illustrates using multiflow to deliver simultaneous data streams.

FIG. 9 illustrates two reference cellular-WLAN interworking architectures for a WLAN and a 3 GPP eNodeB with disjoint bearer routing, in accordance with certain aspects of the present disclosure.

FIG. 10 illustrates an example process for switching bearers between radio access technologies (RATs), in accordance with certain aspects of the present disclosure.

FIGS. 11-16 illustrates example call flow diagrams for communication in a multi-RAT communication system, in accordance with aspects of the present disclosure.

FIG. 17 illustrates example operations that may be performed by a base station for multi-RAT communication system, in accordance with aspects of the present disclosure.

FIG. 18 illustrates example operations that may be performed by a mobile device for multi-RAT communication system, in accordance with aspects of the present disclosure.

FIG. 19 illustrates example operations that may be performed by a transmitting entity for multi-RAT communication system, in accordance with aspects of the present disclosure.

FIGS. 20-22 illustrate example operations that may be performed by a receiving entity for multi-RAT communication system, in accordance with aspects of the present disclosure.

FIG. 23 illustrates example operations that may be performed by a transmitting entity for multi-RAT communication system, in accordance with aspects of the present disclosure.

### DETAILED DESCRIPTION

Aspects of the present disclosure provide various techniques for communicating between a base station (e.g., an eNodeB) and a user equipment (UE) in a multi-RAT system (having at least first and second RATs). In some cases, tunneling may be utilized to allow aggregation, for example, using a wireless wide area network (WWAN) with little impact on an access point (AP) of a wireless local area network (WLAN).

In some cases, a UE may be configured to provide reports allowing the base station to determine information regarding both RATs (e.g., the WWAN and WLAN). In some cases, the base station may send probe packets on both RATs and the UE may report certain information (e.g., relative packet delay or number of dropped packets) back to the base station.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

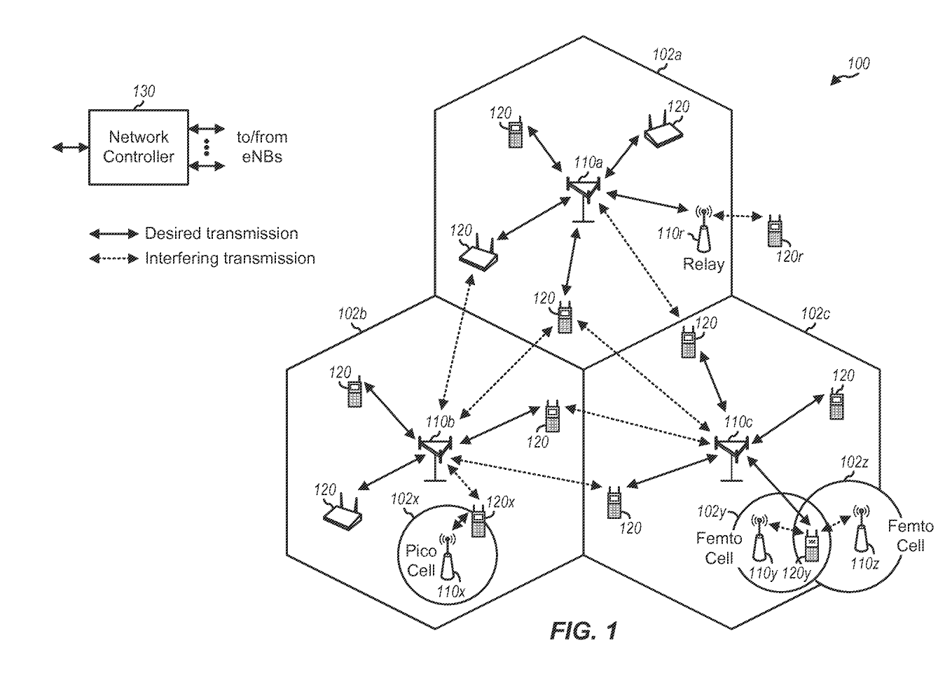

FIG. 1 shows a wireless communication network 100, which may be an LTE network. The wireless network 100 may include a number of evolved Node Bs (eNodeBs) 110 and other network entities. An eNodeB may be a station that communicates with the UEs and may also be referred to as a base station, an access point, etc. A Node B is another example of a station that communicates with the UEs.

Each eNodeB 110 may provide communication coverage for a particular geographic area. In 3GPP, the term “cell” can refer to a coverage area of an eNodeB and/or an eNodeB subsystem serving this coverage area, depending on the context in which the term is used.

An eNodeB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNodeB for a macro cell may be referred to as a macro eNodeB. An eNodeB for a pico cell may be referred to as a pico eNodeB. An eNodeB for a femto cell may be referred to as a femto eNodeB or a home eNodeB. In the example shown in FIG. 1, the eNodeBs 110a, 110b and 110c may be macro eNodeBs for the macro cells 102a, 102b and 102c, respectively. The eNodeB 110x may be a pico eNodeB for a pico cell 102x. The eNodeBs 110y and 110z may be femto eNodeBs for the femto cells 102y and 102z, respectively. An eNodeB may support one or multiple (e.g., three) cells.

The wireless network 100 may also include relay stations. A relay station is a station that receives a transmission of data and/or other information from an upstream station (e.g., an eNodeB or a UE) and sends a transmission of the data and/or other information to a downstream station (e.g., a UE or an eNodeB). A relay station may also be a UE that relays transmissions for other UEs. In the example shown in FIG. 1, a relay station 110r may communicate with the eNodeB 110a and a UE 120r in order to facilitate communication between the eNodeB 110a and the UE 120r. A relay station may also be referred to as a relay eNodeB, a relay, etc.

The wireless network 100 may be a heterogeneous network that includes eNodeBs of different types, e.g., macro eNodeBs, pico eNodeBs, femto eNodeBs, relays, etc. These different types of eNodeBs may have different transmit power levels, different coverage areas, and different impact on interference in the wireless network 100. For example, macro eNodeBs may have a high transmit power level (e.g., 20 Watts) whereas pico eNodeBs, femto eNodeBs and relays may have a lower transmit power level (e.g., 1 Watt).

The wireless network 100 may support synchronous or asynchronous operation. For synchronous operation, the eNodeBs may have similar frame timing, and transmissions from different eNodeBs may be approximately aligned in time. For asynchronous operation, the eNodeBs may have different frame timing, and transmissions from different eNodeBs may not be aligned in time. The techniques described herein may be used for both synchronous and asynchronous operation.

A network controller 130 may couple to a set of eNodeBs and provide coordination and control for these eNodeBs. The network controller 130 may communicate with the eNodeBs 110 via a backhaul. The eNodeBs 110 may also communicate with one another, e.g., directly or indirectly via wireless or wireline backhaul.

The UEs 120 (e.g., 120x, 120y, etc.) may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a tablet, a netbook, a smart book, etc. A UE may be able to communicate with macro eNodeBs, pico eNodeBs, femto eNodeBs, relays, etc. In FIG. 1, a solid line with double arrows indicates desired transmissions between a UE and a serving eNodeB, which is an eNodeB designated to serve the UE on the downlink and/or uplink. A dashed line with double arrows indicates interfering transmissions between a UE and an eNodeB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

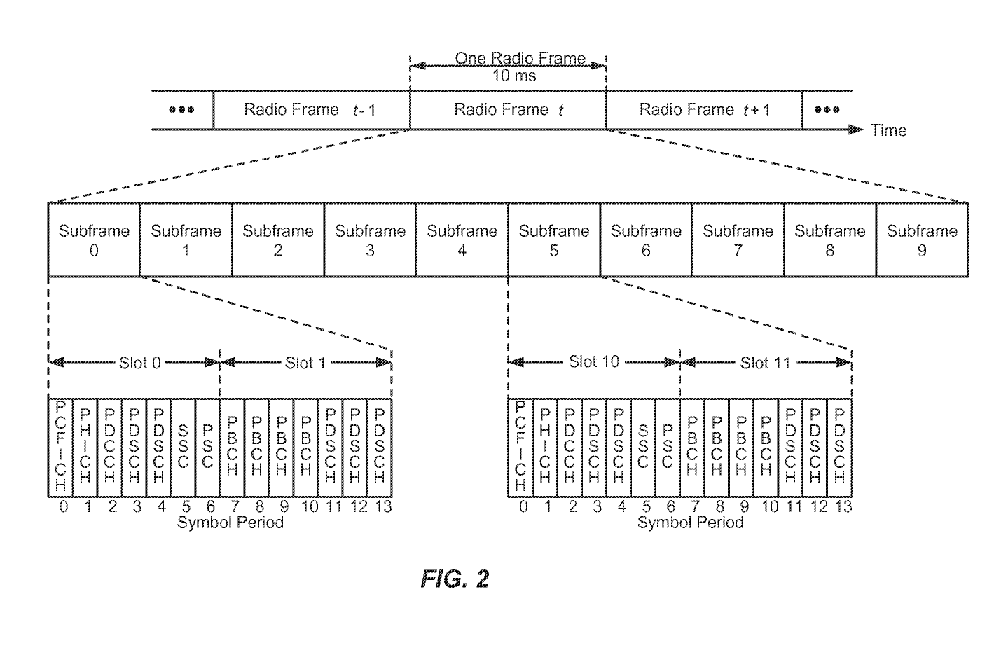

FIG. 2 shows a down link frame structure used in LTE. The transmission timeline for the downlink may be partitioned into units of radio frames. Each radio frame may have a predetermined duration (e.g., 10 milliseconds (ms)) and may be partitioned into 10 sub-frames with indices of 0 through 9. Each sub-frame may include two slots. Each radio frame may thus include 20 slots with indices of 0 through 19. Each slot may include L symbol periods, e.g., 7 symbol periods for a normal cyclic prefix (as shown in FIG. 2) or 14 symbol periods for an extended cyclic prefix. The 2L symbol periods in each sub-frame may be assigned indices of 0 through 2L−1. The available time frequency resources may be partitioned into resource blocks. Each resource block may cover N subcarriers (e.g., 12 subcarriers) in one slot.

In LTE, an eNodeB may send a primary synchronization signal (PSS) and a secondary synchronization signal (SSS) for each cell in the eNodeB. The primary and secondary synchronization signals may be sent in symbol periods 6 and 5, respectively, in each of sub-frames 0 and 5 of each radio frame with the normal cyclic prefix, as shown in FIG. 2. The synchronization signals may be used by UEs for cell detection and acquisition. The eNodeB may send a Physical Broadcast Channel (PBCH) in symbol periods 0 to 3 in slot 1 of sub-frame 0. The PBCH may carry certain system information.

The eNodeB may send a Physical Control Format Indicator Channel (PCFICH) in a portion of the first symbol period of each sub-frame, although depicted in the entire first symbol period in FIG. 2. The PCFICH may convey the number of symbol periods (M) used for control channels, where M may be equal to 1, 2 or 3 and may change from sub-frame to sub-frame. M may also be equal to 4 for a small system bandwidth, e.g., with less than 10 resource blocks. In the example shown in FIG. 2, M=3. The eNodeB may send a Physical HARQ Indicator Channel (PHICH) and a Physical Downlink Control Channel (PDCCH) in the first M symbol periods of each sub-frame (M=3 in FIG. 2). The PHICH may carry information to support hybrid automatic retransmission (HARQ). The PDCCH may carry information on uplink and downlink resource allocation for UEs and power control information for uplink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNodeB may send a Physical Downlink Shared Channel (PDSCH) in the remaining symbol periods of each sub-frame. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNodeB may send the PSS, SSS and PBCH in the center 1.08 MHz of the system bandwidth used by the eNodeB. The eNodeB may send the PCFICH and PHICH across the entire system bandwidth in each symbol period in which these channels are sent. The eNodeB may send the PDCCH to groups of UEs in certain portions of the system bandwidth. The eNodeB may send the PDSCH to specific UEs in specific portions of the system bandwidth. The eNodeB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNodeB may send the PDCCH to the UE in any of the combinations that the UE will search.

A UE may be within the coverage of multiple eNodeBs. One of these eNodeBs may be selected to serve the UE. The serving eNodeB may be selected based on various criteria such as received power, path loss, signal-to-noise ratio (SNR), etc.

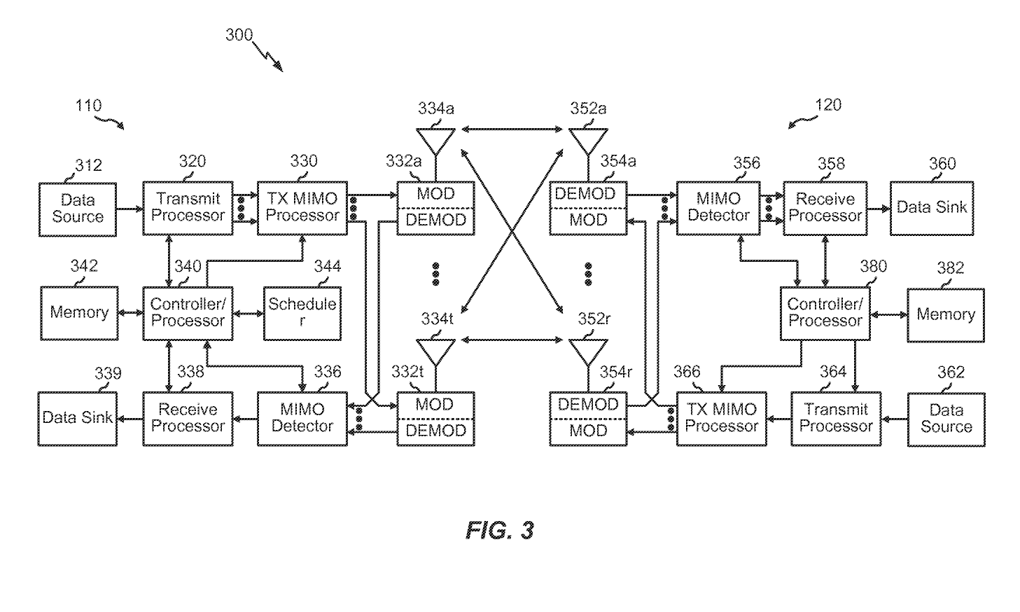

FIG. 3 shows a block diagram of a design of a base station/eNodeB 110 and a UE 120, which may be one of the base stations/eNodeBs and one of the UEs in FIG. 1. For a restricted association scenario, the base station 110 may be the macro eNodeB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from the transmit processor 364 may be precoded by a TX MIMO processor 366 if applicable, further processed by the demodulators 354a through 354r (e.g., for SC-FDM, etc.), and transmitted to the base station 110. At the base station 110, the uplink signals from the UE 120 may be received by the antennas 334, processed by the modulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

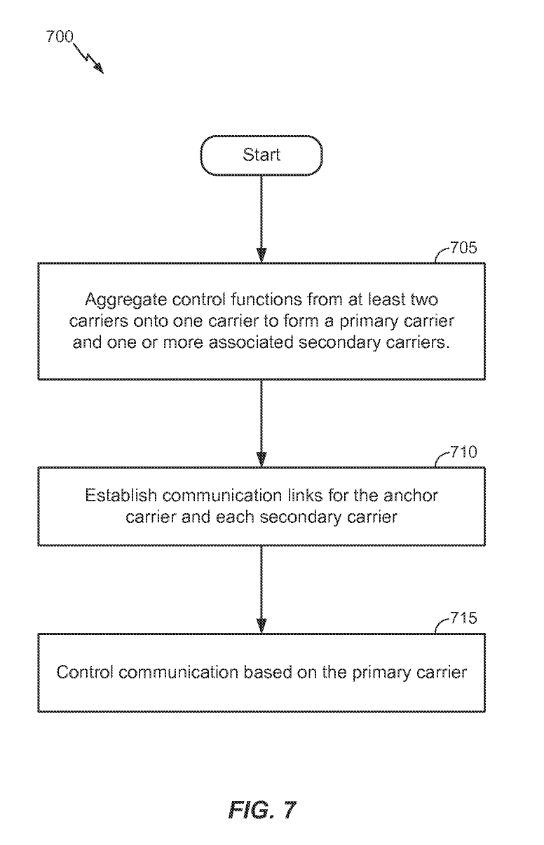

The controllers/processors 340 and 380 may direct the operation at the base station 110 and the UE 120, respectively. The processor 340 and/or other processors and modules at the base station 110 may perform or direct, e.g., the execution of various processes for the techniques described herein. The processor 380 and/or other processors and modules at the UE 120 may also perform or direct, e.g., the execution of the functional blocks illustrated in FIG. 7, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the base station 110 includes means for generating a compact Downlink Control Information (DCI) for at least one of uplink (UL) or downlink (DL) transmissions, wherein the compact DCI comprises a reduced number of bits when compared to certain standard DCI formats; and means for transmitting the DCI. In one aspect, the aforementioned means may be the controller/processor 340, the memory 342, the transmit processor 320, the modulators 332, and the antennas 334 configured to perform the functions recited by the aforementioned means. In another aspect, the aforementioned means may be a module or any apparatus configured to perform the functions recited by the aforementioned means. In one configuration, the UE 120 includes means for receiving compact Downlink Control Information (DCI) for at least one of uplink (UL) or downlink (DL) transmissions, wherein the DCI comprises a reduced number of bits of a standard DCI format; and means for processing the DCI. In one aspect, the aforementioned means may be the controller/processor 380, the memory 382, the receive processor 358, the MIMO detector 356, the demodulators 354, and the antennas 352 configured to perform the functions recited by the aforementioned means. In another aspect, the aforementioned means may be a module or any apparatus configured to perform the functions recited by the aforementioned means.

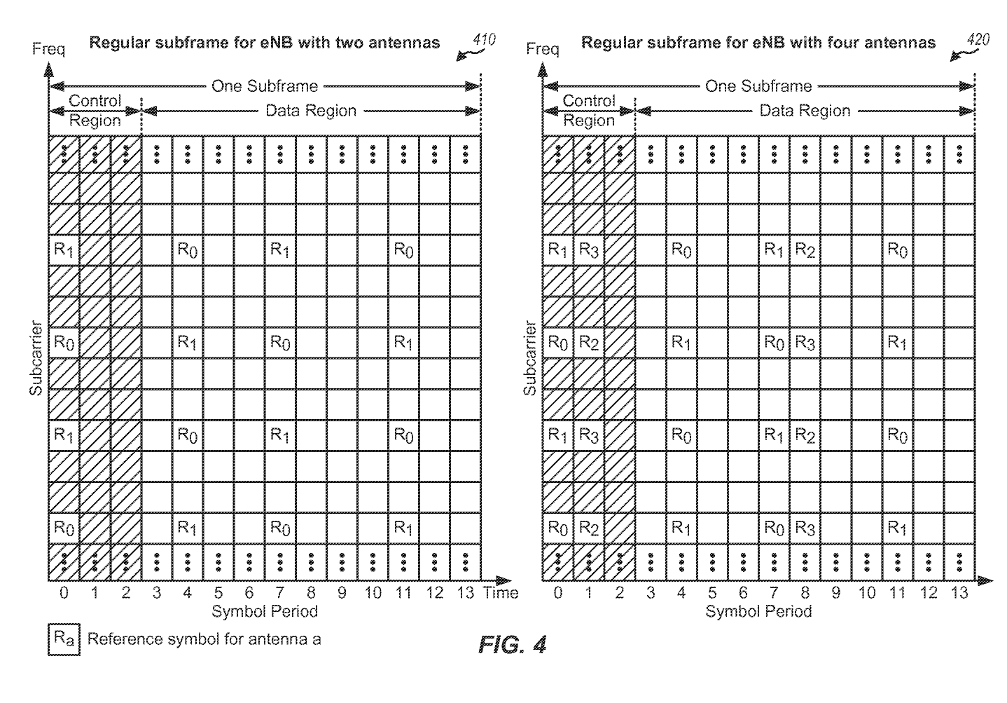

FIG. 4 shows two exemplary subframe formats 410 and 420 for the downlink with the normal cyclic prefix. The available time frequency resources for the downlink may be partitioned into resource blocks. Each resource block may cover 12 subcarriers in one slot and may include a number of resource elements. Each resource element may cover one subcarrier in one symbol period and may be used to send one modulation symbol, which may be a real or complex value.

Subframe format 410 may be used for an eNB equipped with two antennas. A CRS may be transmitted from antennas 0 and 1 in symbol periods 0, 4, 7 and 11. A reference signal is a signal that is known a priori by a transmitter and a receiver and may also be referred to as a pilot. A CRS is a reference signal that is specific for a cell, e.g., generated based on a cell identity (ID). In FIG. 4, for a given resource element with label Rₐ, a modulation symbol may be transmitted on that resource element from antenna a, and no modulation symbols may be transmitted on that resource element from other antennas. Subframe format 420 may be used for an eNB equipped with four antennas. A CRS may be transmitted from antennas 0 and 1 in symbol periods 0, 4, 7 and 11 and from antennas 2 and 3 in symbol periods 1 and 8. For both subframe formats 410 and 420, a CRS may be transmitted on evenly spaced subcarriers, which may be determined based on cell ID. Different eNBs may transmit their CRSs on the same or different subcarriers, depending on their cell IDs. For both subframe formats 410 and 420, resource elements not used for the CRS may be used to transmit data (e.g., traffic data, control data, and/or other data).

The PSS, SSS, CRS and PBCH in LTE are described in 3GPP TS 36.211, entitled “Evolved Universal Terrestrial Radio Access (E-UTRA); Physical Channels and Modulation,” which is publicly available.

An interlace structure may be used for each of the downlink and uplink for FDD in LTE. For example, Q interlaces with indices of 0 through Q−1 may be defined, where Q may be equal to 4, 6, 8, 10, or some other value. Each interlace may include subframes that are spaced apart by Q frames. In particular, interlace q may include subframes q, q+Q, q+2Q, etc., where qε{0, . . . , Q−1}.

The wireless network may support hybrid automatic retransmission (HARQ) for data transmission on the downlink and uplink. For HARQ, a transmitter (e.g., an eNB) may send one or more transmissions of a packet until the packet is decoded correctly by a receiver (e.g., a UE) or some other termination condition is encountered. For synchronous HARQ, all transmissions of the packet may be sent in subframes of a single interlace. For asynchronous HARQ, each transmission of the packet may be sent in any subframe.

A UE may be located within the coverage area of multiple eNBs. One of these eNBs may be selected to serve the UE. The serving eNB may be selected based on various criteria such as received signal strength, received signal quality, pathloss, etc. Received signal quality may be quantified by a signal-to-noise-and-interference ratio (SINR), or a reference signal received quality (RSRQ), or some other metric. The UE may operate in a dominant interference scenario in which the UE may observe high interference from one or more interfering eNBs.

### Carrier Aggregation

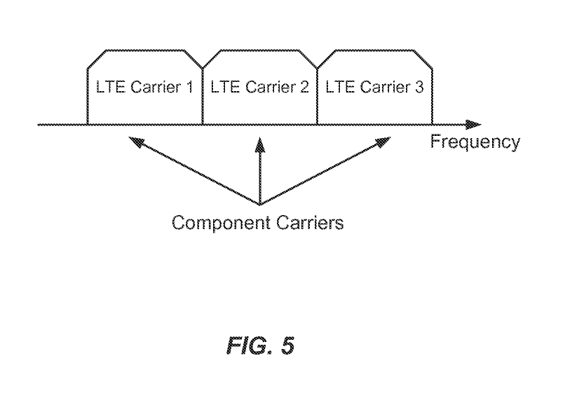

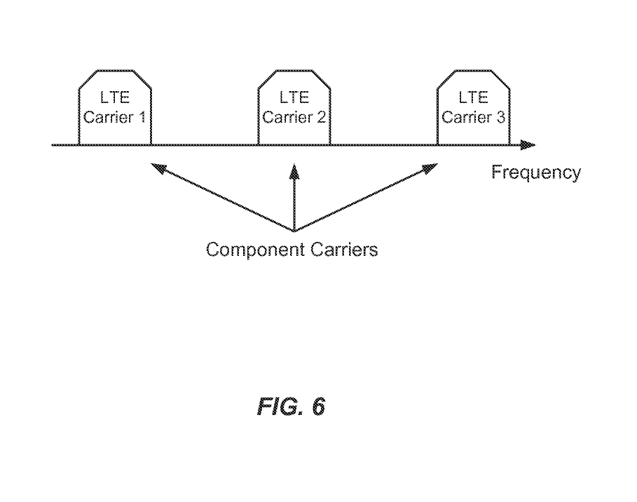

LTE-Advanced UEs may use spectrum of up to 20 MHz bandwidths allocated in a carrier aggregation of up to a total of 100 MHz (5 component carriers) used for transmission in each direction. For the LTE-Advanced mobile systems, two types of carrier aggregation (CA) methods have been proposed, continuous CA and non-continuous CA. They are illustrated in FIGS. 5 and 6. Continuous CA occurs when multiple available component carriers are adjacent to each other (FIG. 5). On the other hand, non-continuous CA occurs when multiple available component carriers are separated along the frequency band (FIG. 6). Both non-continuous and continuous CA aggregate multiple LTE/component carriers to serve a single unit of LTE Advanced UE. According to various examples, the UE operating in a multicarrier system (also referred to as carrier aggregation) is configured to aggregate certain functions of multiple carriers, such as control and feedback functions, on the same carrier, which may be referred to as a “primary carrier.” The remaining carriers that depend on the primary carrier for support are referred to as associated secondary carriers. For example, the UE may aggregate control functions such as those provided by the optional dedicated channel (DCH), the nonscheduled grants, a physical uplink control channel (PUCCH), and/or a physical downlink control channel (PDCCH). FIG. 7 illustrates a method 700 for controlling radio links in a multiple carrier wireless communication system by grouping physical channels according to one example. As shown, the method includes, at block 705, aggregating control functions from at least two carriers onto one carrier to form a primary carrier and one or more associated secondary carriers. Next at block, 710, communication links are established for the primary carrier and each secondary carrier. Then, communication is controlled based on the primary carrier in block 715.

### Multiflow

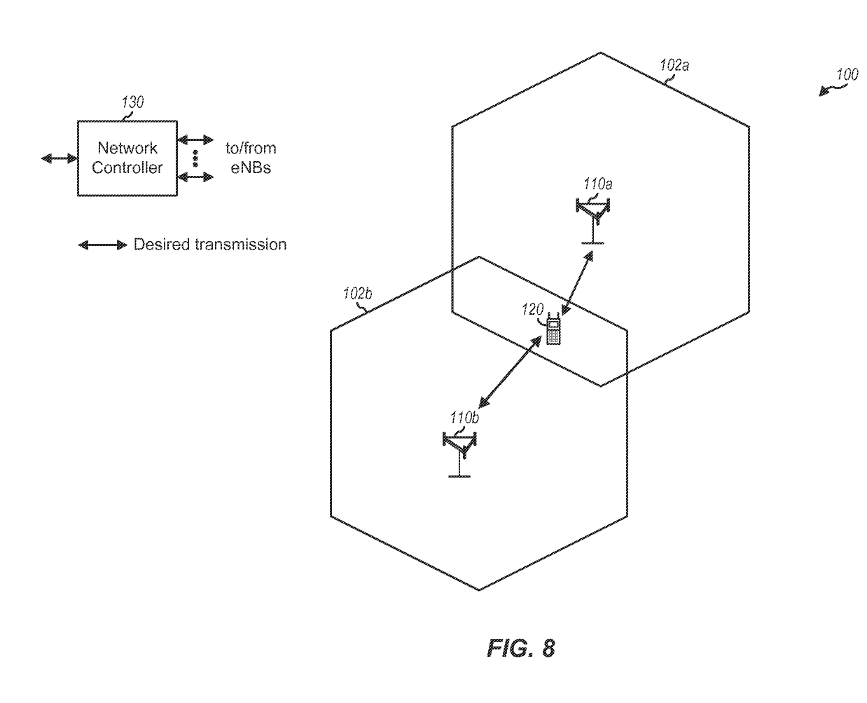

Presently, UEs receive data from one eNodeB. However, users on a cell edge may experience high inter-cell interference which may limit the data rates. Multiflow allows users to receive data from two eNodeBs simultaneously. It works by sending and receiving data from the two eNodeBs in two totally separate streams when a UE is in range of two cell towers in two adjacent cells at the same time. The UE talks to two towers simultaneously when the device is on the edge of either towers' reach (see FIG. 8). By scheduling two independent data streams to the mobile device from two different NodeBs at the same time, multiflow exploits uneven loading in HSPA networks. This helps improve the cell edge user experience while increasing network capacity. In one example, throughput data speeds for users at a cell edge may double. “Multiflow” is similar to dual-carrier HSPA, however, there are differences. For example, dual-carrier HSPA doesn't allow for connectivity to multiple towers to connect simultaneously to a device.

### New Carrier Type

With LTE-A standardization carriers are backward-compatible, enabling smooth transitions to new releases. However, because of this backward-compatibility the carriers continuously transmit common reference signals (CRS, also referred to as cell-specific reference signals) in every subframe across the bandwidth. Most cell site energy consumption is caused by the power amplifier since the cell remains on even when limited control signalling is being transmitted, causing the amplifier to continue to consume energy. CRS were introduced in release 8 of LTE and are LTE's most basic downlink reference signal. They are transmitted in every resource block in the frequency domain and in every downlink subframe. CRS in a cell can be for one, two, or four corresponding antenna ports. CRS may be used by remote terminals to estimate channels for coherent demodulation. A new carrier type allows temporarily switching off of cells by removing transmission of CRS in four out of five sub frames. This reduces power consumed by the power amplifier. It also reduces the overhead and interference from CRS since the CRS won't be continuously transmitted in every subframe across the bandwidth. In addition, the new carrier type allows the downlink control channels to be operated using UE-specific Demodulation Reference Symbols. The New Carrier Type might be operated as a kind of extension carrier along with another LTE/LTE-A carrier or alternatively as standalone non-backward compatible carrier.

### LTE Plus Wi-Fi

With WiFi Offload, the basic idea is whenever a WLAN access point is available, some or all of the traffic is routed through the WLAN access point, thus offloading the cellular access. Mobile operators should be able to control which traffic is routed over WLAN and which one is kept on 3G/4G. For example, some IP flows (e.g., related to VoIP or other operators' services) can be maintained over 3G/4G to leverage its QoS capabilities, while IP flows related to “best-effort” Internet traffic can be offloaded to WLAN. 3GPP introduced a Wi-Fi mobility framework in Release 8 to enable seamless handover between 3G/4G and WLAN.

With interworking, the performance of each of the available links is estimated on a real-time basis, without any user intervention, and the best possible link for the type of application the user is trying to use is selected. The performance estimation looks at a multitude of parameters from an end-to-end perspective, covering not only the last-mile air link to the users, but also all the way back to the Internet. Some of the parameters considered for the decision include signal quality, available bandwidth, speed of the Internet connectivity, latency, as well as the operator policies regarding which apps/services are allowed to be moved to Wi-Fi and which are restricted to 3G/4G. So, the device continuously determines the most appropriate link and switches between 3G/4G and Wi-Fi.

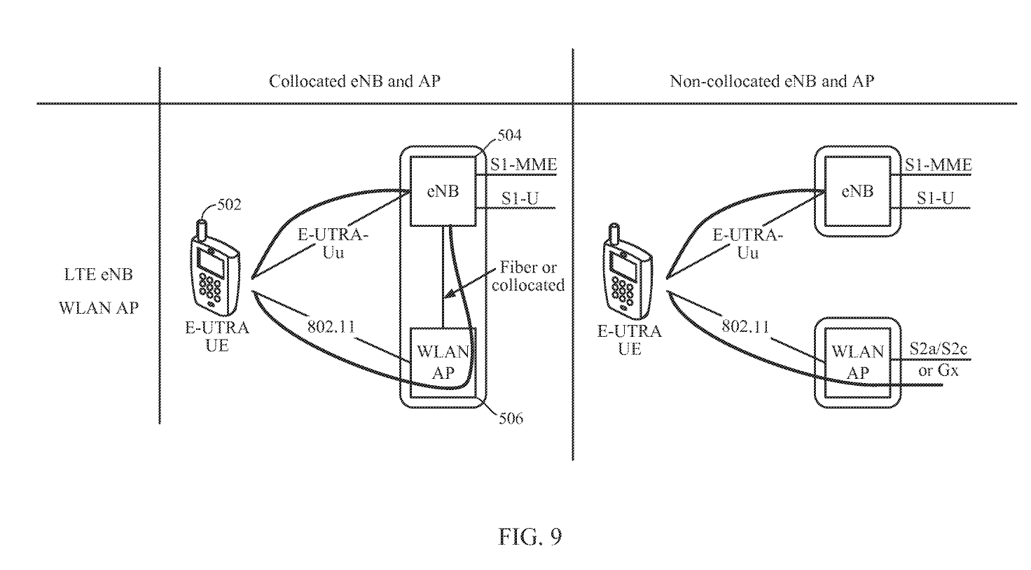

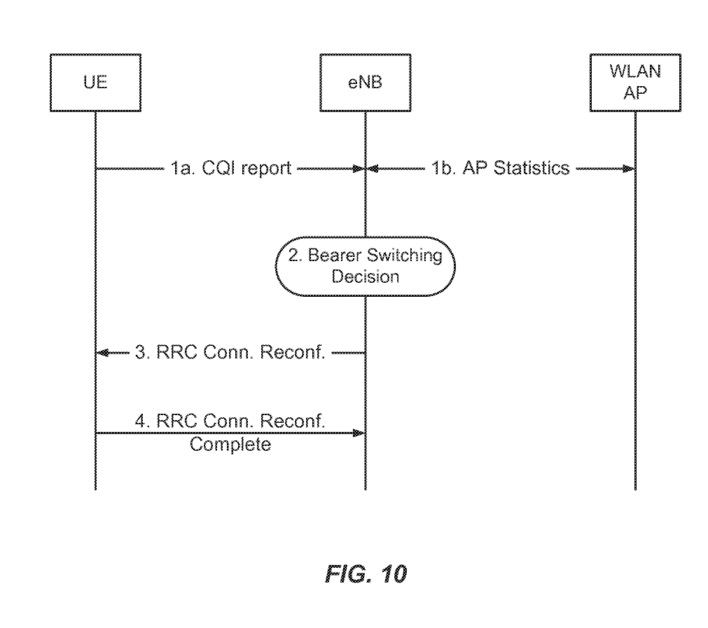

According to certain aspects, a user may be simultaneously connected to an LTE eNB and a Wi-Fi AP, which provide radio access links to transport a user's signaling and data traffic, as shown in FIG. 9. The eNB and the AP may be collocated or non-collocated. A user's data or signaling bearer may be served by either LTE or WiFi radio links. According to certain aspects, methods to determine whether to switch bearers and configure them to be served on LTE or WiFi are described. A bearer establishes a “virtual” connection between two endpoints so that traffic can be sent between them. It acts as a pipeline between the two endpoints. Access to PDN services and associated applications is provided to a UE by EPS bearers. A Default Bearer is typically is established during attachment and maintained throughout the lifetime of the connection. A dedicated bearer is used if the end-user uses connectivity to a different Packet Data Network (PDN) to that provided by the default bearer, or if the end-user uses a different Quality of Service (QoS) to that offered by the default bearer. Dedicated bearers are configured to run in parallel to the existing default bearer. According to certain aspects, whether to switch bearers may be determined based on the main objectives of serving bearers with a “better” link for each bearer, while maximizing a system utility function. According to certain aspects, the better link may be determined based in part on a user's channel conditions, traffic, and other users sharing the same link. The eNB may make the decision to switch bearers between LTE and WiFi and may configure the UE via RRC as shown in FIG. 10. FIG. 10 illustrates a call flow of an exemplary process an eNB may follow in switching data bearers. At 1a and 1b, the eNB may obtain information regarding the channel conditions at the UE (e.g., CQI Report) and the operating statistics of the WLAN AP (e.g., AP Statistics). According to some aspects, the eNB may obtain WLAN statistics from the UE. At 2, the eNB may make the bearer switching decision. At 3, the eNB may send RRC connection reconfiguration commands to the UE, and at 4, the eNB may receive a RRC connection reconfiguration complete message from the UE.

### Tunneling from eNB to STA

Aspects of the present disclosure provide techniques that may be used to communicate in a multi-RAT system to communicate with a UE, for example, via a WWAN base station (e.g., an LTE eNB) and a WLAN access point (e.g., a Wi-Fi AP).

Routing traffic through WLAN access points may cause traffic to traverse the WLAN network. WLAN networks, also referred to herein as IP networks, may be operator deployed or deployed by third parties such as users. These WLAN networks may have diverse network architectures.

Aspects of the present disclosure may help facilitate communications using for LTE-WLAN aggregation, for example, by allowing a UE connecting to an eNB through a WLAN to be able to navigate these network architectures without necessitating changes in the WLAN or AP deployment.

One possible WLAN network architecture includes a WLAN network with network address translation (NAT). NAT allows a set of internet connected devices to utilize a private network IP address space while sharing a smaller set of public IP addresses (typically a single IP address). A NAT may be a stand-alone network device or integrated into an access point (AP), gateway, router, or a link. NAT implementations generally route internal private IP addresses to external public IP address with mapping or translation tables. These tables are generally established by outgoing communications from an internal private IP address, so packets incoming from an external public IP address without a preceding, corresponding outgoing communication from the internal private IP address are generally discarded. To enable traffic originating from an external public IP address to reach an internal private IP address, NAT implementations may use port forwarding. Port forwarding typically operates by configuring the mapping or translation tables with a persistent entry. However, port forwarding may require changing WLAN configurations and typically uses configurations specific to each supported application.

In general, there are four types of NAT servers, full-cone, address-restricted cone, port restricted cone, and symmetric NAT. With a full-cone NAT, once an outbound communication is initiated, the NAT will map an external public IP address to the initiating internal address and any external server can send packets to the internal address via the mapped external public IP address. An address-restricted cone NAT is similar to a full-cone NAT except that only external servers that were previously sent packets by the internal address are allowed to send packets to the internal address via the mapped external public IP address. A port-restricted cone NAT is similar to an address-restricted cone NAT where the external server is contacted by the internal address and transmits to a designated port (ex: port 80). A symmetric NAT maps each request from an internal address to a specific external server to a different external public IP address and port.

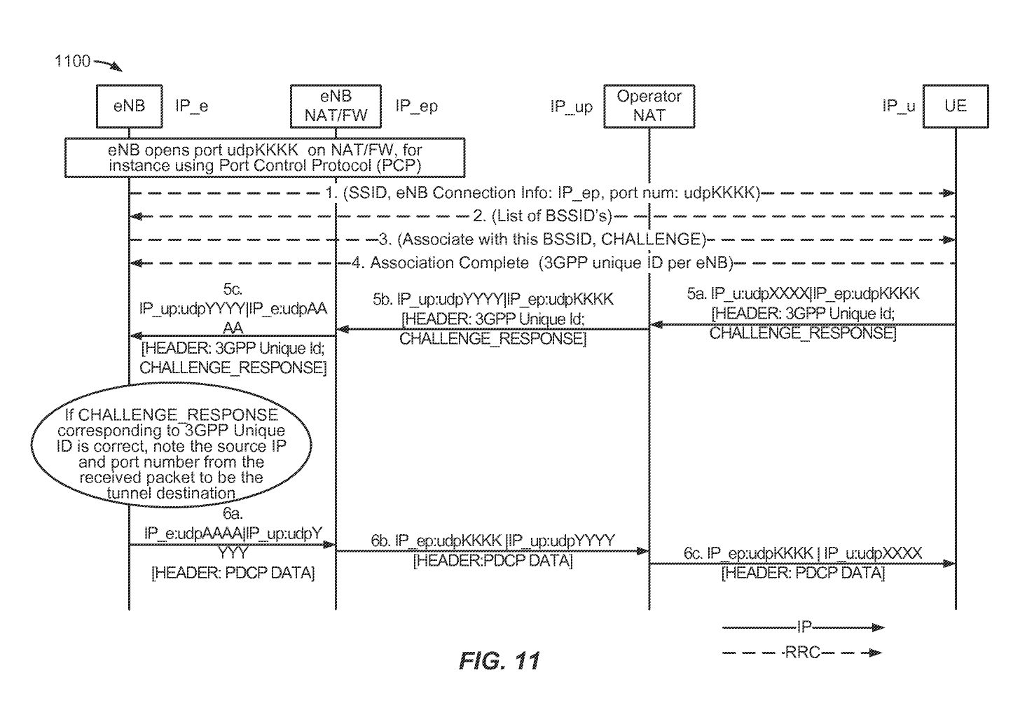

FIG. 11 illustrates an example call flow for tunneling operations initiated by the UE, in accordance with aspects of the present disclosure. An eNB may be networked on an IP network behind an operator NAT and firewall (eNB NAT/FW), as well as on a radio access network (RAN), and connected by both the RAN and IP network to the UE. The UE may be located behind an Operator (WLAN) NAT on the IP network and configured to send and receive commands and data via both RRC and IP. In the illustrated example, an eNB supporting UE initiated tunneling is configured to open a particular port on the eNB NAT and listen on the particular port. Opening a port may be accomplished using computer networking protocols such as Port Control Protocol (PCP), which returns a number corresponding to the port opened, here udpKKKK, to the eNB. Other techniques may also be used to configure the eNB to be reachable by the UE over a non-cellular IP network, such as TURN, a relay, a proxy, using a public address, etc.

At step 1, after a determination to aggregate the WiFi carrier, the eNB indicates to the UE via RRC a WiFi identifier, such as a service set identifier (SSID), an IP address where the eNB may be reached, and/or a port number (IP_ep, port num udpKKKK) to enable the UE to contact the eNB through an IP protocol. The SSID may indicate a preferred WLAN network. The port number sent by the eNB corresponds to the port number of the previously opened port. The IP address is an external public IP address that the UE may use to contact the eNB. This is a public address through which the UE can contact the eNB, irrespective of the particular network deployment in use. In another example the eNB may have a public IP address and indicate it to the UE. The IP address may be an IP version 4 or IP version 6 address. At step 2, the UE provides the basic service set identifiers (BSSID's) of the WiFi networks the UE can access. At step 3, the eNB selects a WiFi network among the ones indicated and sends to the UE the corresponding BSSID along with a security CHALLENGE to the UE. The UE may then associate with the designated WiFi network and acquire an IP address from the WLAN. At step 4, the UE completes the association and indicates the completion back to the eNB. Steps 1-4 may be performed, for example, through RRC signaling, or other WWAN signaling.

At step 5a-5c, the UE constructs an IP packet containing the unique ID of the UE along with the security CHALLENGE_RESPONSE, and sends this packet to the eNB over the WiFi network identified in step 3 to the eNB's external public IP address and port identified in step 1. As the UE sends the initial IP request to the eNB, the request traverses the WLAN and the operator NAT converts the UE's internal IP address to the UE's external IP address and establishes the operator NAT's mapping tables, at step 5a. At step 5b, the packet is then directed to the external IP address of the eNB to the eNB NAT, which receives the packet and converts the eNB's public IP address to the eNB's private IP address. At step 5c, the packet traverses the eNB NAT and is received by the eNB.

After the eNB receives the packet from the UE, the eNB checks the CHALLENGE_RESPONSE corresponding to the unique ID of the UE is correct. If the CHALLENGE_RESPONSE is correct, the eNB notes the source IP and port number from the packet as the tunnel destination. At 6a-6c, the eNB may then send IP data to the UE via the WLAN through the tunnel. This tunnel may utilize a variety of internet protocols, such as HTTP or UDP. At step 6a, the eNB transmits a packet addressed to the external IP address of the UE. The packet may contain PDCP data. At step 6b, the eNB NAT converts the internal IP address of the eNB to the external IP address. A routing table may also be established. This IP data may include a header consisting of Packet Data Convergence Protocol (PDCP) data, Radio Link Protocol (RLC) data, aggregation PDUs, or other cellular radio protocol data. Thus for the UE initiated tunnel, the eNB opens and listen on a port, as well as provide the eNB's IP address.

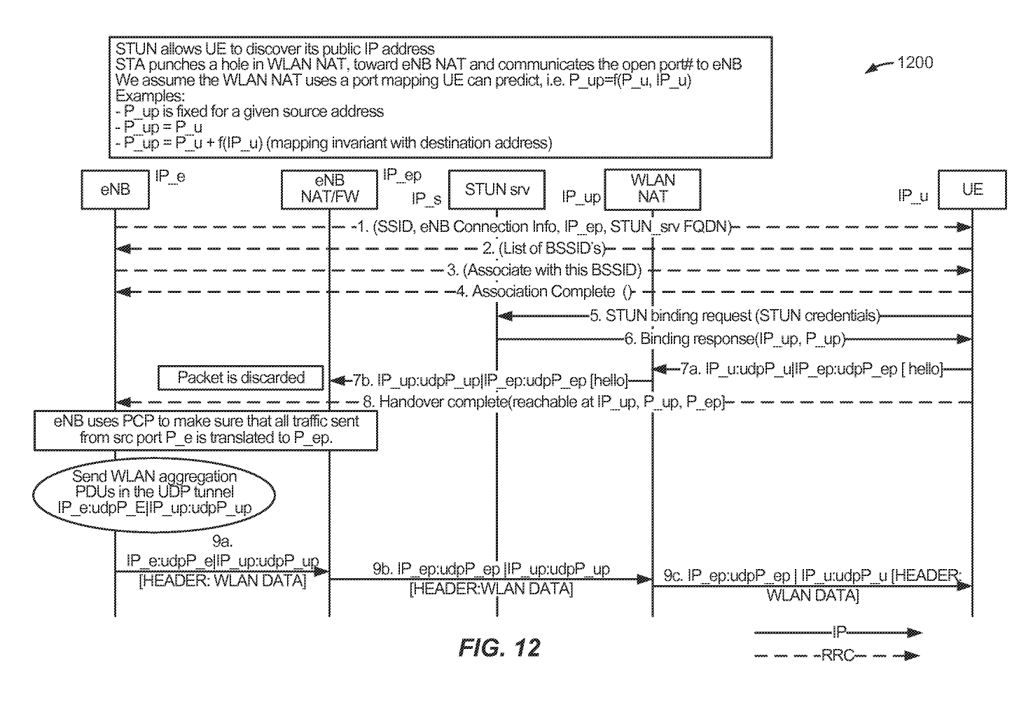

FIG. 12 illustrates an exemplary call flow for tunneling operations via a Session Traversal Utilities for NAT (STUN) server, in accordance with aspects of the present disclosure. A UE or eNB located behind a NAT may discover its public IP address using the STUN protocol and STUN server. A STUN server may act as an intermediary and respond back to the UE or eNB, allowing the UE or eNB to determine their public IP address. The tunneling operations may be performed, for example, by an eNB networked behind a NAT and firewall (eNB NAT/FW), and connected by a cellular and IP network to a UE, which may also be behind a WLAN NAT.

As illustrated, a UE may also be located behind an Operator NAT on the IP network and configured to receive commands and data via both RRC and IP packets. This configuration may assume a WLAN NAT with a predictable port mapping. For example, a WLAN may be configured such that the uplink port is fixed for a given source address (for example, HTTP port 80), that the extremal uplink port is the same was the internal uplink port, or that the internal uplink port is a function of the external uplink port. A STUN server configured on the IP network may be located between the eNB NAT/FW and the Operator NAT. The STUN server may, for example, be operated by the wireless operator, the WLAN operator, or a third party. The eNB may provide a STUN server address to the UE in step 1. Operations for selecting a WLAN at steps 1 and 2 otherwise operate similarly to those as described in conjunction with FIG. 11. Similarly, at step 3 the eNB selects a WiFi network and sends to the UE the corresponding BSSID. The UE may then associate with the designated WiFi network and acquire an IP address from the WLAN. At step 4, the association is complete and the UE may send an acknowledgement.

At step 5, the UE becomes reachable by the eNB over the IP protocol. In one configuration the UE constructs and sends, over the IP network, a STUN binding request to the STUN server with the appropriate authentication and credentials. The UE may discover the STUN server prior to the binding request via WLAN Dynamic Host Configuration Protocol (DHCP) and querying the DNS server, or the eNB may signal the address of an appropriate STUN server via RRC. The STUN server receives the binding request, verifies the authentication and/or credentials as needed and notes the external public IP address the binding request originated from. At step 6, the STUN server responds to the UE with the external public IP address and port number from the binding request. In other examples, the UE may discover the STUN server via RRC signaling from the eNB or via a static configuration.

At step 7a-7b, a hole is punched through the WLAN NAT by the UE sending a packet to the eNB over the WiFi network identified in step 3, to the eNB's external public IP address and port identified in step 1. This packet traverses the WLAN and operator NATs and establishes the NAT's mapping tables. This packet reaches the eNB NAT at step 7b, where the eNB NAT creates a mapping, allowing packets to flow in the reverse direction from the eNB to the UE. At step 8, the UE sends to the eNB, via RRC signaling, the public IP address and port where the UE can be reached which enables the eNB to route data to the UE. Steps 7a-7b may be optional depending on the IP network configuration and the eNB NAT configuration.

Prior to steps 9a-9c, the eNB may use PCP or another technique to open and configure a port on the eNB NAT/FW to forward traffic addressed to the eNB's public IP address to the eNB's private IP address. In steps 9a-9c, the eNB sends WLAN aggregation PDU data using the IP address provided by the UE at step 8 and established the tunnel to the UE. This tunnel, as discussed above, may utilize a variety of internet protocols, such as HTTP or UDP. At step 9a, the eNB then sends IP data addressed to the UE via the eNB NAT/FW, establishing the eNB NAT/FW mapping tables. At steps 9b-9c, the IP data is transmitted to the UE by the IP network. In addition, the eNB may use PCP to ensure the eNB NAT translates the internal private address of the eNB to the correct external public IP address and port.

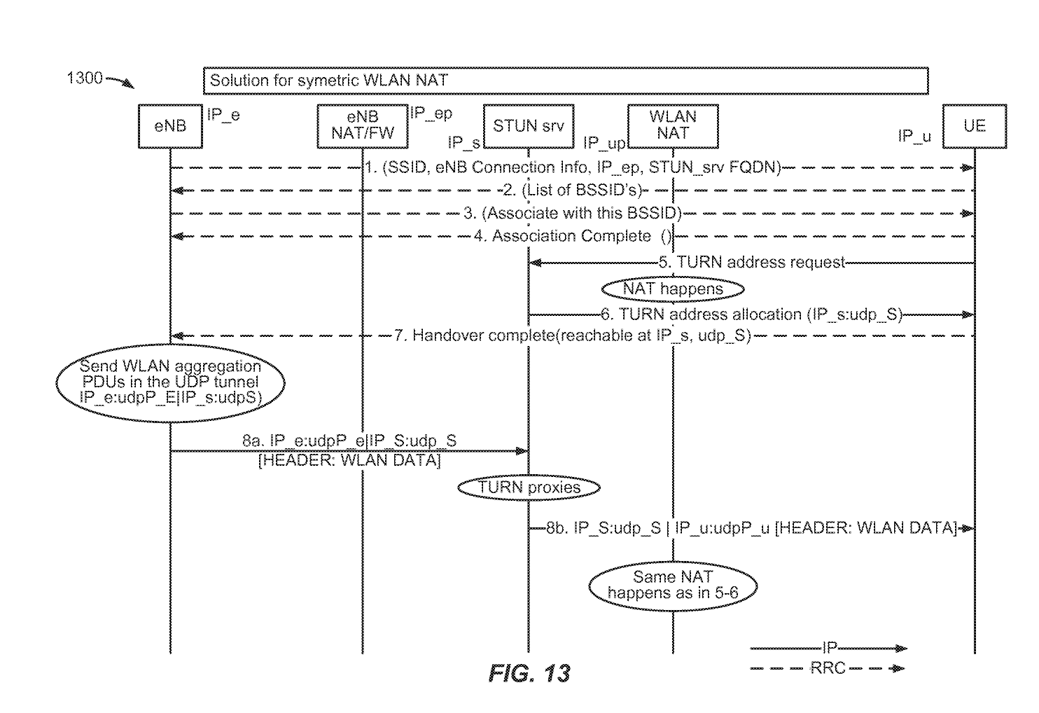

FIG. 13 illustrates an exemplary call flow for tunneling operations UE initiated tunneling via a Traversal Using Relays around NAT (TURN) server, in accordance with aspects of the present disclosure.

Certain NAT implementations, such as a symmetric NAT are known to be incompatible with STUN. In the case of symmetric NAT, because the NAT maps each request from an internal address to a specific external server and port, the external public IP address and port returned by a STUN server will not work with a different external server. A TURN server addresses the limitations of STUN by working as a relay or proxy. A TURN server acts as a Proxy to the eNB by sitting between the eNB and the UE and forwards, or relays, messages between the UE and the eNB. A TURN server acts as a relay for sending packets between the UE and eNB. Therefore, the tunneling operations may be performed, as before, by an eNB behind a eNB NAT/FW, connected by a cellular and IP network to a UE behind an Operator NAT on the IP network, and a TURN server configured on the IP network between the eNB NAT/FW and the Operator NAT. The TURN server may be operated by, for example, the wireless operator, the WLAN operator, or a third party.

The eNB may provide a TURN server address to the UE in step 1. Forwarding operations at 1 and 2 otherwise operate similarly to those as described in conjunction with FIG. 11 and FIG. 12. Steps 3 and 4 operate similarly to those described in conjunction with FIG. 12. At step 5, the UE transmits over the IP network a request to the TURN server requesting resources, consisting of the TURN server's proxy address, i.e., IP/port allocation. This sets up the operator NAT's mapping tables for the TURN server and provides the TURN server with the UE's external public IP address. The TURN server responds in step 6 by indicating to the UE the accessible relay IP address and port that the TURN server will forward to the UE. This address acts as a relaying address for the UE. At step 7, the UE sends to the eNB, via RRC signaling, the accessible relay IP address and port allocated by the TURN server, where the UE can be reached. At step 8a, the eNB then sends IP data addressed to the UE to TURN server. The TURN server, at 8b, then uses the external public IP address associated with the UE to relay the IP data to the UE. By using the TURN address, instead of its own, the UE becomes reachable by the eNB.

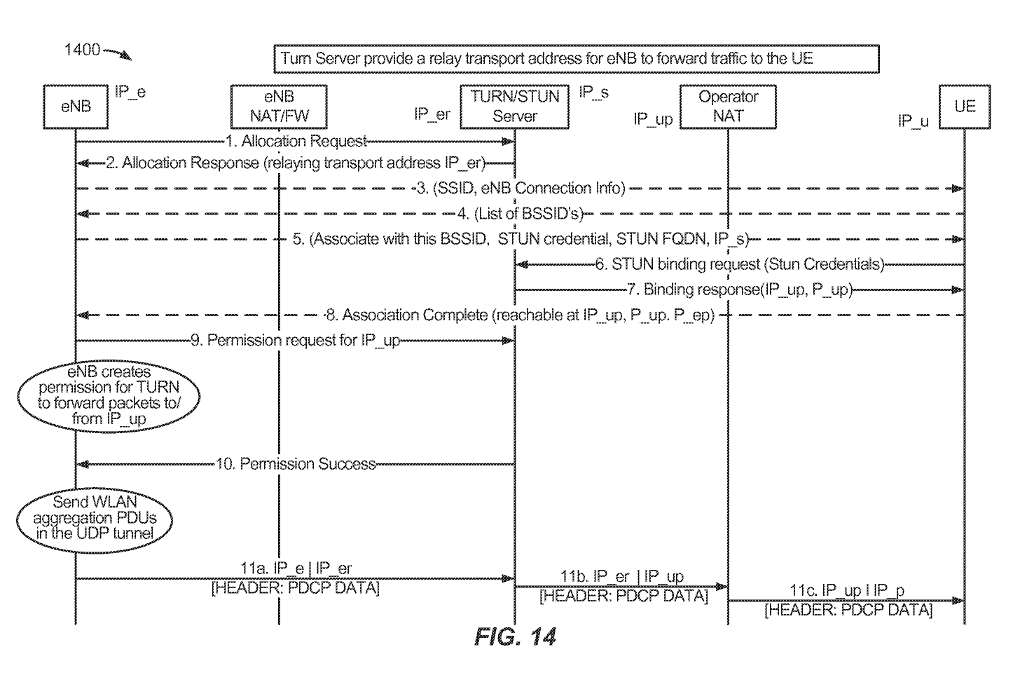

FIG. 14 illustrates another exemplary call flow for tunneling operations UE initiated tunneling via a TURN/STUN server. In certain implementations, it may be advantageous for the UE not to have the IP address of the eNB. The tunneling operations may be performed, as before, by an eNB behind an eNB NAT/FW, connected by a cellular and IP network to a UE behind an Operator NAT on the IP network, and a TURN/STUN server configured on the IP network between the eNB NAT/FW and the Operator NAT. The TURN/STUN server may be operated, for example, by the wireless operator and support both TURN and STUN.

At step 1, the eNB transmits over the IP network an allocation request to the TURN server. The TURN/STUN server receives the allocation request and responds to the eNB with the allocation response relaying a transport address IP of the TURN/STUN server in step 2. At step 3, the eNB indicates to the UE via RRC a WiFi identifier, such as an SSID, as well as the relaying transport IP address of the TURN/STUN server. At step 4, the UE provides the BSSID's of the WiFi networks the UE can access.

At step 5, the eNB selects a WiFi network and sends to the UE the corresponding BSSID along with credentials to the TURN/STUN server and the relaying transport IP address of the TURN/STUN server. At step 6, the UE transmits over the IP network a binding request to the TURN/STUN server. This request may include the credentials to the TURN/STUN server, relayed to the UE in step 5. At step 7, the TURN/STUN server responds with a binding response containing the external public IP address of the UE.

At step 8, the UE sends to the eNB, via RRC signaling, the external public IP address of the UE. After receiving the external public IP address of the UE, at step 9, the eNB requests permission from the TURN server to forward packet to and from the external public IP address of the UE. At step 10, the TURN server responds with an indication that permission is granted. At step 11a, the eNB transmits IP data packets, which may comprise, for example, WLAN aggregation PDUs, over the IP network to the TURN server, which relays these IP data packets to the Operator NAT in step 11b, and onto the UE in step 11c.

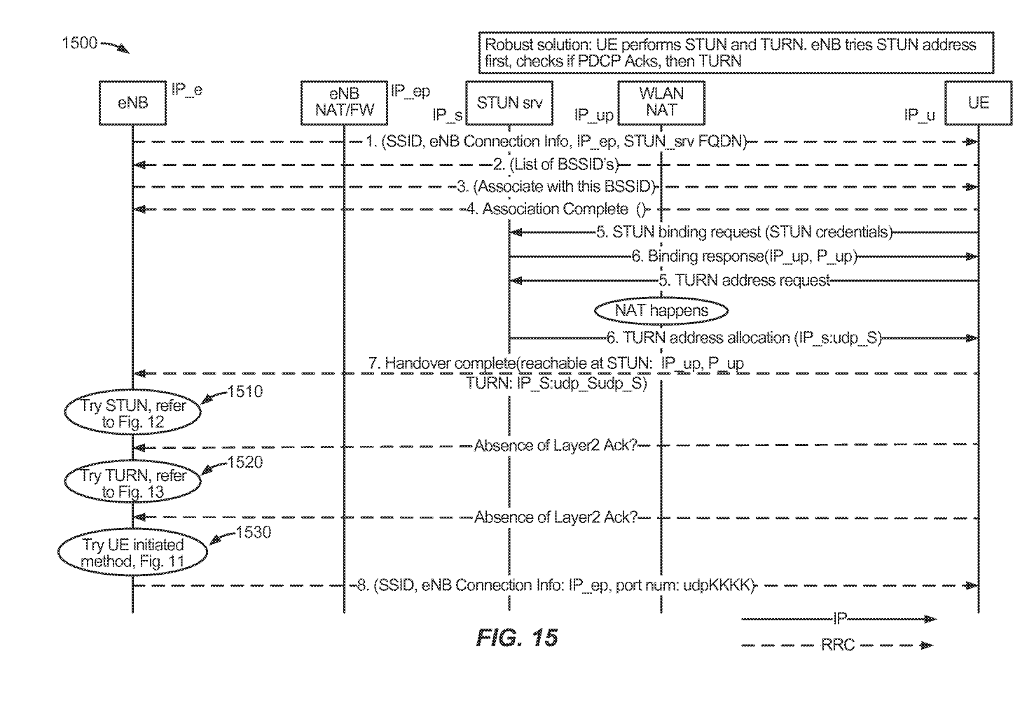

FIG. 15 illustrates an exemplary call flow for a robust tunneling operation, in accordance with aspects of the present disclosure. In this example, different techniques described above may be tried, for example, in a prioritized manner.

While TURN offers compatibility with a broader range of NAT configurations as compared to STUN, the intermediary relay used in TURN may consume additional server resources or increase network latency by acting as a relay. To optimize resource usage, a UE or eNB may be configured to attempt to establish a WLAN tunnel based on a service priority. In one example, an eNB may be configured to first attempt to connect to the UE using STUN, and if that fails, using TURN, and finally falling back to an UE initiated method.

The tunneling operations may be performed, as before, by an eNB behind an eNB NAT/FW, connected by a cellular and IP network to a UE behind an Operator NAT on the IP network, a TURN server configured on the IP network between the eNB NAT/FW and the Operator NAT, and a STUN server configured on the IP network between the eNB NAT/FW and the Operator NAT. In certain examples, the TURN and STUN servers may be configured on the same server or server cluster. The TURN and STUN servers may be operated by, for example, the wireless operator, the WLAN operator, or a third party. The eNB may transmit a STUN and or TURN server address to the UE in step 1.

Forwarding operations at 1 and 2 may otherwise operate similarly to those as described in conjunction with FIG. 11 and FIG. 12. Steps 3 and 4 operate similarly to those described in conjunction with FIG. 12. Steps 5 and 6 operate similarly to those described in conjunction with FIG. 12. At step 7, the UE transmits over the IP network a list of means through which the UE can be reached. The list may include a STUN address (IP_up, P_up) and a TURN address (IP_S:udp_Sudp_S). The eNB may attempt to reach the UE using the different means, in some order of priority. In the example illustrated in FIG. 15, the eNB first attempts the STUN address to send data to the UE. If layer 2 of UE does not acknowledge the data, the eNB then attempts the TURN address to send data to the UE. If layer 2 of UE does not acknowledge the data, the eNB may attempt methods where the eNB provides its IP address to the UE to set up a tunnel, such as the UE initiated method as described in conjunction with FIG. 11. The example shown in FIG. 15 is only one example and an eNB may attempt to reach a UE in any order of priority and may attempt to use other protocols.

At 1510, as described above with reference to FIG. 12, steps 7a-7b and 9a-9c, a hole is punched through the WLAN NAT, and the eNB attempts to send IP data addressed to the UE using the STUN address. If the eNB is unable to establish a connection with the UE using the STUN address, for example if the operator NAT is a symmetric NAT and discards the IP data sent by the eNB, the eNB may then try to connect using TURN.

At 1520, as described above with reference to FIG. 13, steps 8a and 8b, the eNB then sends the IP data to the TURN server, which relays the IP data to the UE. In one example, if the eNB is still unable to establish a connection with the UE via the TURN server, UE initiated tunneling may be attempted.

At step 1530, as described above with reference to FIG. 11, step 1, the eNB may open a port in the eNB NAT/FW and indicate to the UE via RRC a WiFi identifier, such as an SSID, an IP address where the eNB may be reached, and a port number. UE initiated tunneling may then proceed as described in FIG. 11, steps 2-6c.

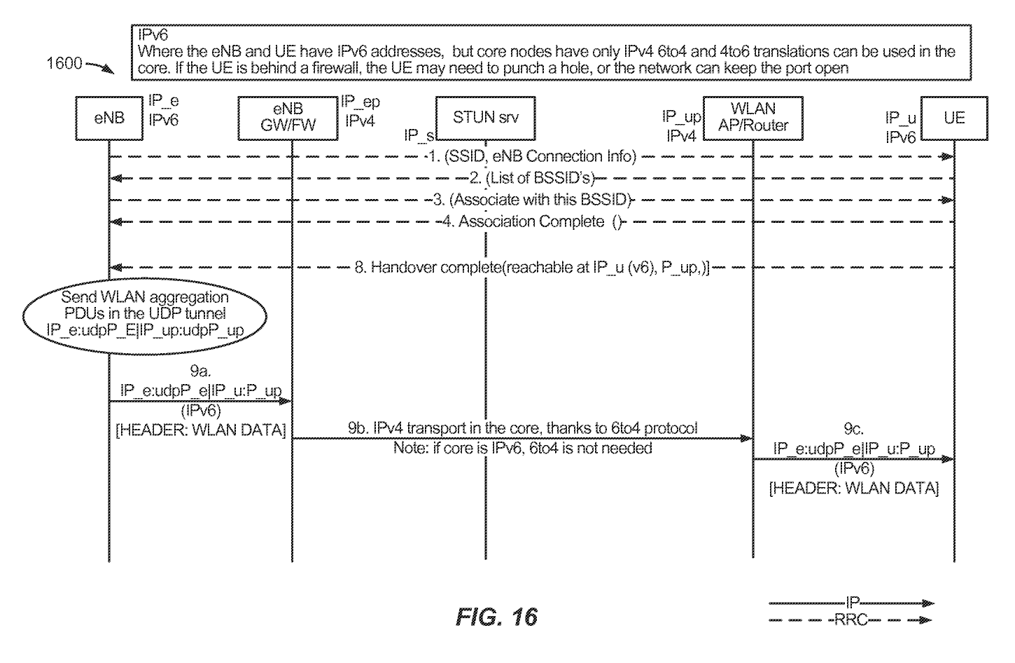

FIG. 16 illustrates an exemplary call flow for an IPv6 tunneling operation, in accordance with aspects of the present disclosure. The tunneling operations may be performed, for example, by an eNB which supports IPv6 and connected by a cellular and IP network to a UE. According to some configurations, the IPv6 network may not be configured with NAT servers as IPv6 offers significantly more IP addresses than an IPv4 network. In this example, this UE may also support IPv6 and is configured to receive commands and data via both RRC and IP packets. In addition, the IP network may comprise IPv4, IPv6 or a mixture of IPv4 and IPv6. A core network, such as the internet, may utilize IPv4, while networks on the edges, such as the networks behind the eNB and WLAN NATs respectively, may utilize IPv6. In such a configuration, the eNB and WLAN networks may include a router or access point which performs 6to4 or 4to6 address translation. A UE may, after associating with an AP on an IPv6 network with an IPv4 core network, obtain a 6to4 prefix from the AP and generate its IPv6 address from this prefix. The UE may then provide this IPv6 address to the eNB via RRC signaling. The eNB may also obtain a 6to4 address from the eNB AP/FW. Forwarding operations at 1-4 may be similar to those as described above with reference to FIG. 12.

At step 8, the UE sends, to the eNB, its 6to4 address via RRC signaling. At step 9a-c, the eNB sends RLC/PDCP packets inside IPv6 packets to the destination port that UE is listening to. The eNB source IP address is a 6to4 address generated from the eNB's own IPv4 address, and the destination address is the UE 6to4 IPv6 address. At 9b, when packets arrive at the router/GW in the RAN network, router/GW tunnels 6to4 packets to the AP, where the source of the tunnel is the v4 address in the source 6to4 address and the destination of the tunnel is the v4 address in the destination 6to4 address.

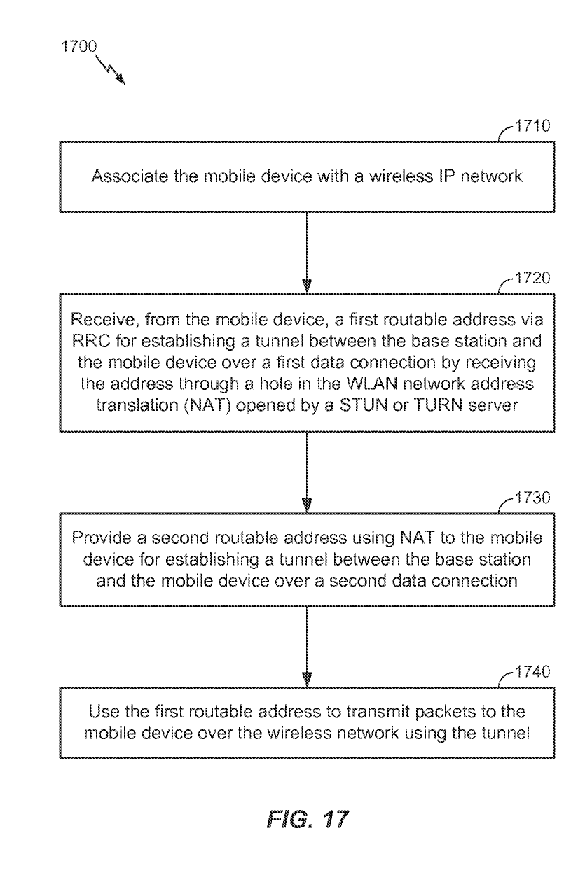

FIG. 17 illustrates example operations 1700 for wireless communications by a base station (e.g., an eNB). The operations 1700 may begin, at 1710, by associating the mobile device with a wireless IP network. At 1720, the eNB may receive, from the mobile device, a plurality of routable addresses via RRC for establishing a tunnel between the base station and the mobile device over a first data connection. The eNB may try the addresses according to a set order of preference, until discovering one that allows the eNB to communicate with the UE. At 1730, the eNB may provide an additional routable address to the mobile device using NAT for establishing a tunnel between the base station and the mobile device over a second data connection. At 1740, the eNB may use the first routable address to transmit packets to the mobile device over the wireless network using the tunnel

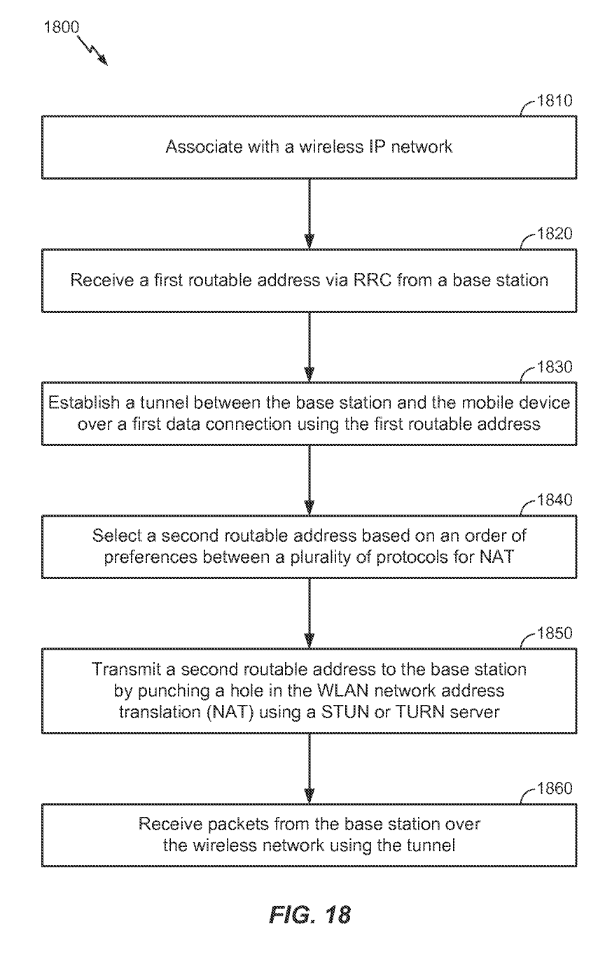

FIG. 18 illustrates example operations 1800 for wireless communications by a mobile device (e.g., a UE). The operations 1800 begin, at 1810, by associating with a wireless IP network. At 1820, the UE receives a first routable address via RRC from a base station. At 1830 a tunnel is established between the base station and the mobile device over a first data connection using the first routable address. At 1840, a second routable address is selected based on an order of preferences between a plurality of protocols. At 1850, the UE transmits a second routable address to the base station by punching a hole in the WLAN NAT using a STUN or TURN server. At 1860, the UE receives packets from the base station over the wireless network using the tunnel

### Scheduling for Over the Top Aggregation of WLAN Carrier to LTE

Aspects of the present disclosure may help an eNB in scheduling transmissions in a multi-RAT system, for example, based on information fed back from the UE. In some cases, the UE may be configured to provide reports allowing the base station to determine information regarding both RATs (e.g., the WWAN and WLAN). In some cases, the base station may send probe packets on both RATs and the UE may report certain information (e.g., relative packet delay between a first and second RAT or number of dropped packets) back to the base station.

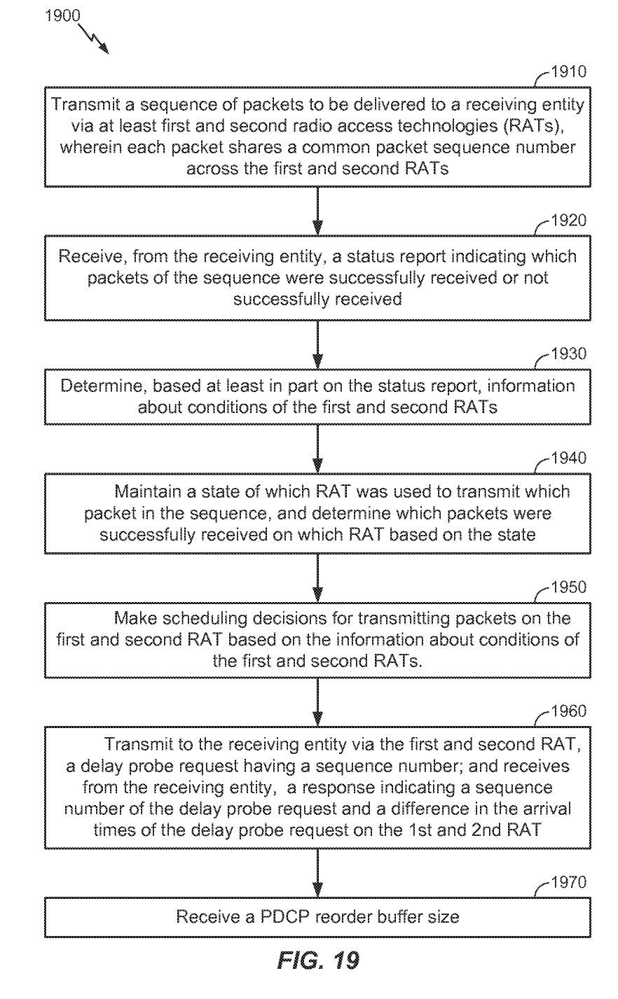

FIG. 19 illustrates example operations 1900 for wireless communications by a transmitting entity (e.g., an eNB or UE). The operations 1900 may begin, at 1910, by transmitting a sequence of packets to be delivered to a receiving entity via at least first and second radio access technologies (RATs), wherein each packet shares a common packet sequence number across the first and second RATs. At 1920, the transmitting entity receives, from the receiving entity, a status report indicating which packets were successfully received and which were not successfully received. At 1930, the transmitting entity determines, based at least in part on the status report, information about conditions of the first and second RATs. At 1940, the transmitting entity maintains a state of which RAT was used to transmit which packet in the sequence and determine which packets were successfully received on which RAT based on the state. At 1950, the transmitting entity makes scheduling decisions for transmitting packets on the first and second RAT based on the information about conditions of the first and second RATs. At 1960, the transmitting entity transmits to the receiving entity via the first and second RAT, a delay probe request having a sequence number, and receives from the receiving entity, a response indicating a sequence number of the delay probe request and a difference in the arrival times of the delay probe request on the 1st and 2nd RAT. At 1970, the transmitting entity receives a PDCP reorder buffer size.

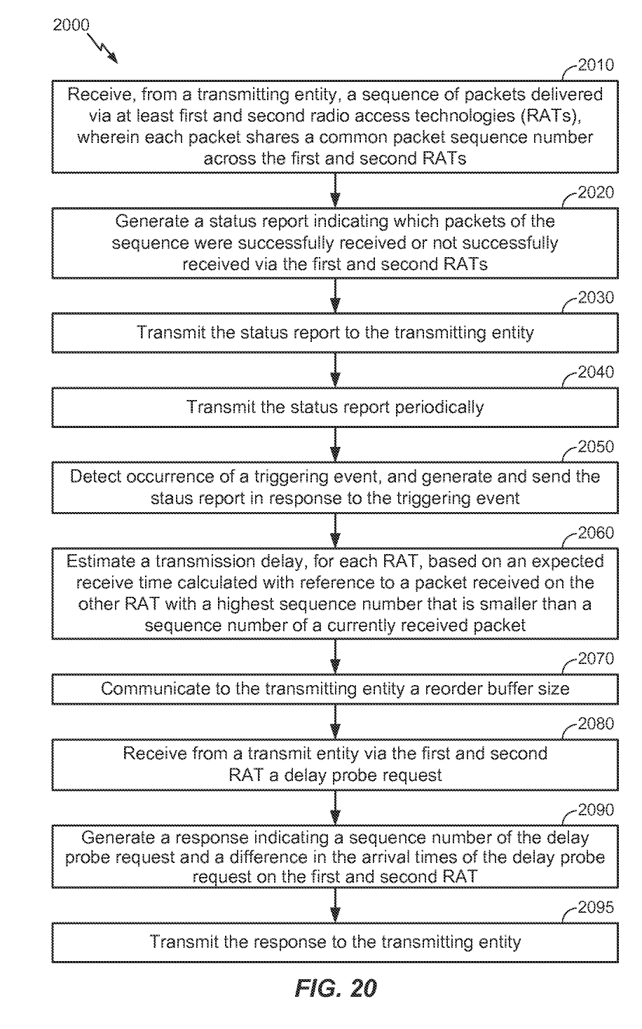

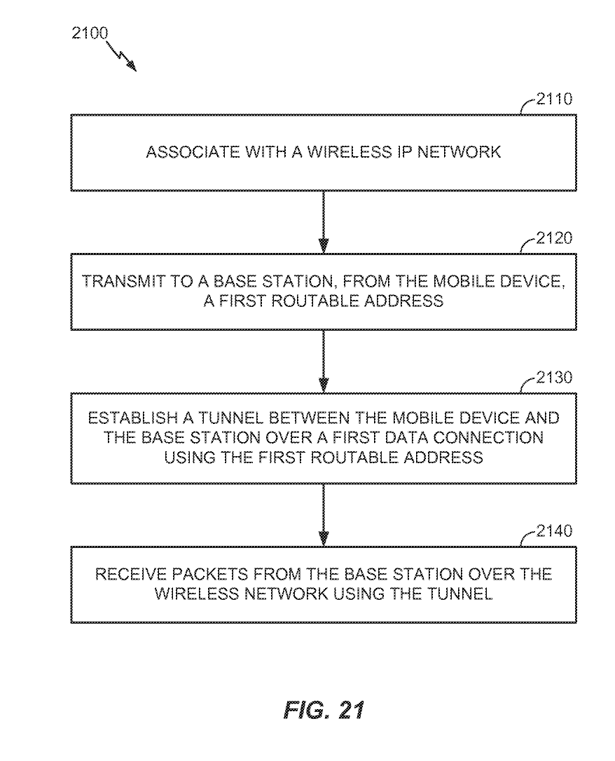

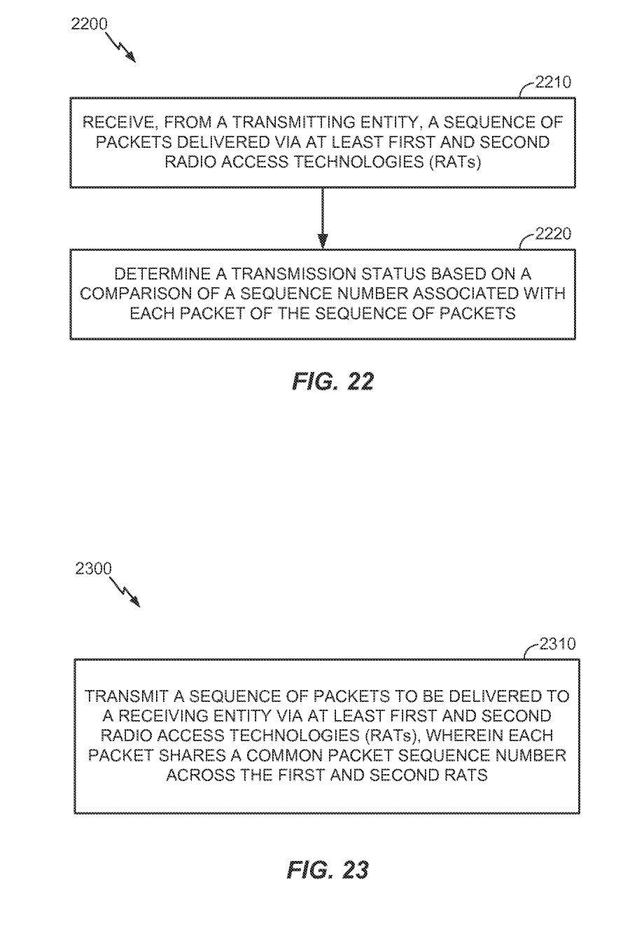

FIG. 20 illustrates example operations 2000 for wireless communications by a receiving entity. The operations 2000 may begin, at 2010, by receiving, from a transmitting entity, a sequence of packets delivered via at least first and second radio access technologies (RATs), wherein each packet shares a common packet sequence number across the first and second RATs. At 2020, the receiving entity receives, from the receiving entity, a status report indicating which packets were successfully received and which were not successfully received. At 2030, the receiving entity determines, based at least in part on the status report, information about conditions of the first and second RATs. At 2040, the receiving entity

1. An apparatus for wireless communications, comprising:
at least one processor configured to:
associate with a wireless IP network, transmit to a base station, from the mobile device, a first routable address, establish a tunnel between the mobile device and the base station over a first data connection using the first routable address, and receive, packets from the base station over the wireless network using the tunnel; and
a memory coupled to the processor.

2. The apparatus of claim 1 wherein the processor is further configured to receive a second routable address from the base station.

3. The apparatus of claim 1, wherein the first routable address is transmitted via Radio Resource Control (RRC) signaling.

4. The apparatus of claim 1, wherein the first routable address comprises an address of at least one of a session traversal utilities for NAT (STUN) and/or traversal using relays around NAT (TURN) server.

5. The apparatus of claim 2, wherein the second routable address comprises an address of at least one of a session traversal utilities for NAT (STUN) and/or traversal using relays around NAT (TURN) server.

6. The apparatus of claim 2, wherein the second routable address is received via Radio Resource Control (RRC) signaling.

7. The apparatus of claim 2, wherein receiving the second routable address further comprises using network address translation, and wherein the mobile device discovers a public address of the base station.

8. The apparatus of claim 2, wherein transmitting the first routable address further comprises punching a hole in the WLAN network address translation (NAT) using a STUN server, wherein the first routable address is a public IP address.

9. The apparatus of claim 2, wherein transmitting the first routable address further comprises punching a hole in the WLAN network address translation (NAT) using a proxy server to relay the first routable address between the mobile device and the base station.

10. The apparatus of claim 9, wherein the proxy server is a TURN server.

11. The apparatus of claim 1, wherein the first routable addresses comprise one of an IPv4 or IPv6 address.

12. The apparatus of claim 2, wherein:
transmitting the first routable address comprises transmitting an address obtained via a session traversal utilities for NAT (STUN) server and an address obtained via a traversal using relays around NAT (TURN) server.

13. An apparatus for wireless communications, comprising:
at least one processor configured to:
associate a mobile device with a wireless IP network, receive, from a base station, a first routable address for establishing a tunnel between the base station and the mobile device over a first data connection, and use the first routable address to transmit packets to the mobile device over the wireless network using the tunnel; and
a memory coupled to the processor.

14. The apparatus of claim 13 wherein the processor is further configured to provide a second routable address to the mobile device.

15. The apparatus of claim 13, wherein the first routable address is transmitted via Radio Resource Control (RRC) signaling.

16. The apparatus of claim 13, wherein the first routable address comprises an address of at least one of a session traversal utilities for NAT (STUN) and/or traversal using relays around NAT (TURN) server.

17. The apparatus of claim 14, wherein the second routable address comprises an address of at least one of a session traversal utilities for NAT (STUN) and/or traversal using relays around NAT (TURN) server.

18. The apparatus of claim 14, wherein the second routable address is received via Radio Resource Control (RRC) signaling.

19. The apparatus of claim 14, wherein providing the second routable address further comprises using network address translation, and wherein the mobile device discovers a public address of the base station.

20. The apparatus of claim 14, wherein receiving the first routable address further comprises receiving through a hole in the WLAN network address translation (NAT) using a STUN server, wherein the first routable address is a public IP address.

21. The apparatus of claim 14, wherein receiving the first routable address further comprises receiving through a hole in the WLAN network address translation (NAT) using a proxy server to relay the first routable address between the mobile device and the base station.

22. The apparatus of claim 21, wherein the proxy server is a TURN server.

23. The apparatus of claim 13, wherein the first routable addresses comprise one of an IPv4 or IPv6 address.

24. The apparatus of claim 14, wherein:
receiving the first routable address comprises receiving an address obtained via a session traversal utilities for NAT (STUN) server and an address obtained via a traversal using relays around NAT (TURN) server; and
determining a priority for using the address obtained via the STUN server or the address obtained via the TURN server as the first routable address.

25. An apparatus for wireless communications, comprising:
at least one processor configured to:
receive, from a transmitting entity, a sequence of packets delivered via at least first and second radio access technologies (RATs) and determine a transmission status based on a comparison of a sequence number associated with each packet of the sequence of packets; and
a memory coupled to the processor.

26. The apparatus of claim 25, wherein the determining comprises estimating a transmission delay, for each RAT, based on an expected receive time calculated with reference to a packet received on the other RAT with a sequence number that is smaller than a sequence number of a currently received packet.

27. The apparatus of claim 26, wherein the processor is further configured to:
detect when a difference between a transmission delay for packets delivered via the first RAT and a transmission delay for packets delivered via the second RAT exceeds a threshold value; and
send a status report in response to the detection.

28. The apparatus of claim 25, wherein the processor is configured to:
determine the transmission status by evaluating a quality metric against a quality threshold, wherein the quality metric is based on whether one or more of the sequence numbers associated with each packet of the sequence of packets, are missing; and
take one or more actions based on the evaluation of the quality metric.

29. An apparatus for wireless communications, comprising:
at least one processor configured to:
transmit a sequence of packets to be delivered to a receiving entity via at least first and second radio access technologies (RATs), wherein each packet shares a common packet sequence number across the first and second RATs; and
a memory coupled to the processor.

30. The apparatus of claim 29, wherein the processor is further configured to:
receive, from the receiving entity, a status report indicating which packets of the sequence were successfully received or not successfully received; and
determine, based at least in part on the status report, information about conditions of the first and second RATs.
